(19) United States
(12) Patent Application Publication
(10) Pub. No.: US 2008/0147771 A1
(43) Pub. Date: Jun. 19, 2008

(54) Reverse Address Lookup in a Mobile Device

(75) Inventor: Robert Bertolino, North Andover, MA (US)

Correspondence Address: CUENOT & FORSYTHE, L.L.C., 12230 FOREST HILL BLVD., STE. 120, WELLINGTON, FL, 33414, US

(73) Assignee: INTERNATIONAL BUSINESS MACHINES CORPORATION, Armonk, NY (US)

(21) Appl. No.: 11/609,969

(22) Filed: Dec. 13, 2006

(51) Int. Cl. G06F 15/16; G06F 3/048

(52) U.S. Cl. 709/201; 715/811

(57) ABSTRACT

Contact information can be determined within a mobile device. An address can be selected from a list of received communications in the mobile device. Over a wireless connection, contact information for the address can be requested. Contact information for the selected address can be received over the wireless connection.

### BACKGROUND OF THE INVENTION

Mobile devices have become pervasive. Many users have come to rely upon mobile devices such as mobile phones, wireless personal digital assistants, laptop computers, and the like. Mobile devices capable of placing and receiving calls typically include a list of the various calls that have been received by the mobile device. These numbers, if included within an internal address book of the mobile device, traditionally are listed using the name that has been associated with the number in the address book.

### BRIEF SUMMARY OF THE INVENTION

The present invention relates to a method of determining contact information within a mobile device. The method can include selecting an address from a list of received communications in the mobile device and requesting, over a wireless connection, contact information for the selected address. Contact information for the selected address can be received over the wireless connection.

The present invention also relates to a mobile device. The mobile device can include at least one network adapter that communicates over a wireless connection. The mobile device further can include a data storage device comprising addresses and contact information associated with the addresses. The mobile device also can include a controller. The controller can initiate a reverse directory lookup function through the network adapter over the wireless connection for a selected address of a communication received by the mobile device.

The present invention also relates to a computer program product including a computer-usable medium having computer-usable program code that, when executed by an information processing system, performs the various steps and/or functions described herein.

### BRIEF DESCRIPTION OF THE SEVERAL VIEWS OF THE DRAWINGS

FIG. 1 is a block diagram illustrating a system in accordance with one aspect of the present invention.

FIG. 2 is a block diagram of a mobile device in accordance with another aspect of the present invention.

FIG. 3 is a view of a graphical user interface in accordance with another aspect of the present invention.

FIG. 4 is a flow chart illustrating a method of retrieving contact information in accordance with another aspect of the present invention.

### DETAILED DESCRIPTION OF THE INVENTION

As will be appreciated by one skilled in the art, the present invention may be embodied as a method, system, or computer program product. Accordingly, the present invention may take the form of an entirely hardware embodiment, an entirely software embodiment, including firmware, resident software, micro-code, etc., or an embodiment combining software and hardware aspects that may all generally be referred to herein as a “circuit”, “module”, “system”, or “device”.

Furthermore, the invention may take the form of a computer program product accessible from a computer-usable or computer-readable medium providing program code for use by, or in connection with, a computer or any instruction execution system. For the purposes of this description, a computer-usable or computer-readable medium can be any apparatus that can contain, store, communicate, propagate, or transport the program for use by, or in connection with, the instruction execution system, apparatus, or device.

Any suitable computer-usable or computer-readable medium may be utilized. For example, the medium can include, but is not limited to, an electronic, magnetic, optical, electromagnetic, infrared, or semiconductor system (or apparatus or device), or a propagation medium. A non-exhaustive list of exemplary computer-readable media can include an electrical connection having one or more wires, an optical fiber, magnetic storage devices such as magnetic tape, a removable computer diskette, a portable computer diskette, a hard disk, a rigid magnetic disk, an optical storage medium, such as an optical disk including a compact disk-read only memory (CD-ROM), a compact disk-read/write (CD-R/W), or a DVD, or a semiconductor or solid state memory including, but not limited to, a random access memory (RAM), a read-only memory (ROM), or an erasable programmable read-only memory (EPROM or Flash memory).

A computer-usable or computer-readable medium further can include a transmission media such as those supporting the Internet or an intranet. Further, the computer-usable medium may include a propagated data signal with the computer-usable program code embodied therewith, either in baseband or as part of a carrier wave. The computer-usable program code may be transmitted using any appropriate medium, including but not limited to the Internet, wireline, optical fiber, cable, RF, etc.

In another aspect, the computer-usable or computer-readable medium can be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Computer program code for carrying out operations of the present invention may be written in an object oriented programming language such as Java, Smalltalk, C++ or the like. However, the computer program code for carrying out operations of the present invention may also be written in conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modems, wireless transceivers, and Ethernet cards are just a few of the currently available types of network adapters.

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

The present invention relates to determining contact information corresponding to addresses used for communications. As used herein, an address can include, but is not limited to, a telephone number, whether for a conventional telephone or a mobile phone, an electronic mail address, a text message address, an instant messaging address, or some other identifier used to route communications to a destination or indicate the source of a communication. Accordingly, a communication can include, but is not limited to, a telephone call, an instant message, a text message, an electronic mail, or the like.

A mobile device can receive communications. For selected ones of the communications, a reverse directory lookup function can be implemented. The reverse directory lookup function can be conducted over a wireless Internet connection. Contact information received in response to the request can be processed within the mobile device according to user preferences. These and other aspects of the present invention will be described with reference to the figures below.

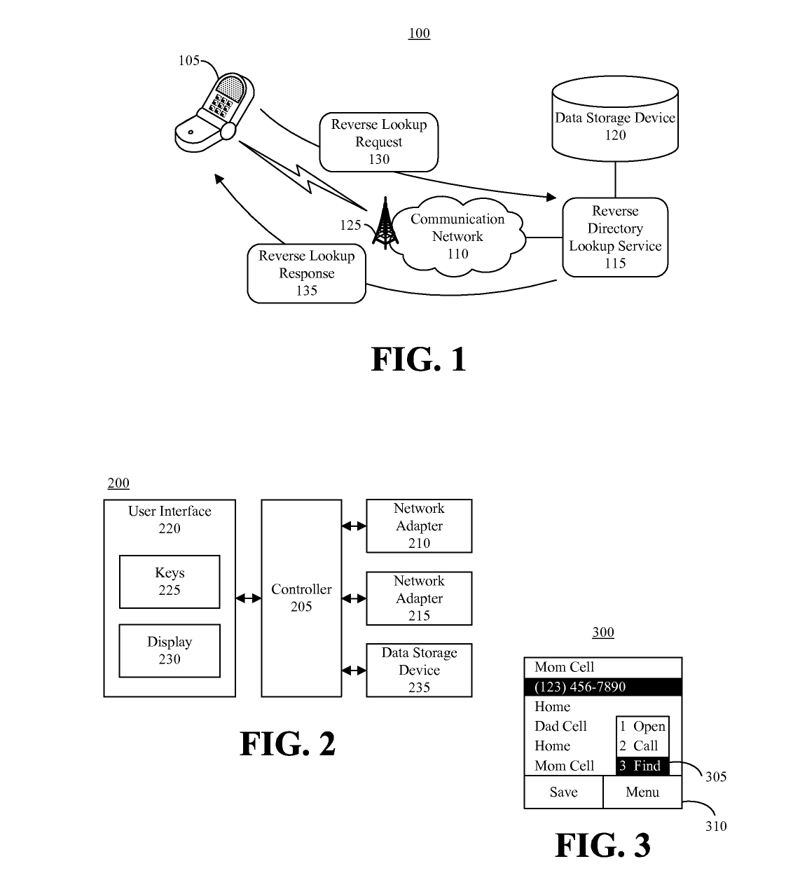

FIG. 1 is a block diagram illustrating a system 100 in accordance with one aspect of the present invention. As shown, the system 100 can include a mobile device 105, a communication network 110, a reverse directory lookup service (RDLS) 115, and a data storage device 120. The mobile device 105 can be implemented as a mobile phone or station, a personal digital assistant, a portable computer capable of mobile communications, or the like. The particular type of mobile device 105 is not intended to limit the present invention so long as the device can perform the various functions described herein.

The communication network 110 can be implemented as, or include, without limitation, a WAN, a LAN, the Public Switched Telephone Network (PSTN), the Web, the Internet, and one or more intranets. The communication network 110 further can include one or more wireless networks, whether short or long range. For example, in terms of short range wireless networks, the communication network 110 can include a local wireless network built using Bluetooth or one of the IEEE 802 wireless communication protocols, i.e., 802.11a/b/g/i, 802.15, 802.16, 802.20, Wi-Fi Protected Access (WPA), or WPA2. In terms of long range wireless networks, the communication network 110 can include a mobile, cellular, and or satellite-based wireless network and support voice, video, text, and/or any combination thereof, i.e., WAP, GSM, TDMA, CDMA, and/or WCDMA network.

The communication network 110 can include one or more access points, such as access point 125. The access point 125 can be implemented as a short range wireless access point, a base station, etc. As such, the wireless access point 125 can support any of a variety of different communication protocols to establish a wireless connection with the mobile device 105 and facilitate communication between the mobile device 105 and the communication network 110. Once communication is established, communication between the mobile device 105 and the RDLS 115 can be established.

In one embodiment, the RDLS 115 can be implemented as a Web service that is accessible via the Internet. In that case, the mobile device 105 can establish communications with the RDLS 115 via the communication network 110 via a wireless Internet connection. In another embodiment, the RDLS 115 can be implemented as part of a mobile network. In that case, the mobile device 105 can issue requests and receive data from the RDLS 115 in the form of text messages, e.g., using Short Message Service (SMS), that are exchanged over the voice channel of the mobile network.

The data storage device 120 can include a directory of addresses and corresponding contact information for the addresses. For example, the directory can include addresses such as telephone numbers, electronic mail address, etc. Associated with the various addresses can be contact information, for example, a name, a mailing (physical) address, as well as other supplemental information. It should be appreciated that while shown as a separate entity, the data storage device 120 can be included within the RDLS 115, for example, within a server hosting the RDLS 115.

In operation, the mobile device 105 can issue a request 130 for a reverse directory lookup function for a selected address, e.g., a telephone number that is listed in a list of received calls in the mobile device 105. It should be appreciated that the process described herein further can be applied to instant messages, electronic mails, or the like if so desired. In any case, the request 130 can be sent via a wireless Internet connection via communication network 110 and be provided, or directed, to the RDLS 115. The RDLS 115 can locate any contact information that is associated with the address provided by the request 130 and send such contact information back to the mobile device 105 in the form of a response 135.

FIG. 2 is a block diagram of a mobile device 200 in accordance with another aspect of the present invention. The mobile device 200 can be configured to operate as discussed with reference to FIG. 1. As shown, the communication device 200 can include a controller 205, one or more network adapters 210 and 215, and a user interface 220. The controller 205 can comprise, for example, one or more central processing units (CPUs), one or more digital signal processors (DSPs), one or more application specific integrated circuits (ASICs), one or more programmable logic devices (PLDs), a plurality of discrete components that can cooperate to process data, and/or any other suitable processing device. These components can be coupled together to perform various processing functions as described herein.

The network adapters 210 and 215 can modulate and demodulate signals to convert signals from one form to another. Each of the network adapters 210 and 215 can receive and/or transmit such signals over various wireless communication networks. In illustration, the network adapter 210 can be configured to communicate data via IEEE 802 wireless communications, for example, 802.11 and 802.16 (WiMax), WPA, or WPA2. In another example, the network adapter 215 can communicate data via GSM, TDMA, CDMA, WCDMA, WAP, or direct wireless communication. Fewer or additional network adapters can be included within the communication device 200. Further, it should be appreciated that, in some cases, a single network adapter can send and receive communications of different varieties. As such, the particular number of network adapter included within the communication device 200 and/or the particular communication protocols used are not intended to limit the present invention.

The user interface 220 can include one or more keys 225 which can be disposed within a keypad, one or more programmable keys, or both. A programmable key refers to a key that can be used to initiate any of a variety of different programmatic actions within the communication device 200 according to the particular operating state in which the communication device 200 is disposed at the time the programmable key is actuated or activated. The user interface 220 also can include a display 230. Other mechanisms (not shown) for obtaining user input and providing feedback to a user can be provided in the user interface 220. For example, the communication device 200 can include various sensors, audio input and output transducers, etc.

The communication device 200 also can include a data storage device 235. The data storage device 235 can include, but is not limited to, a magnetic storage medium, an electronic storage medium, an optical storage medium, a magneto-optical storage medium, and/or any other storage medium suitable for storing digital information such as an address book and program code that, when executed, can cause a processor or controller, such as controller 205, to execute one or more of the functions described herein. In one arrangement, the data storage device 235 can be integrated into the controller 205, though this need not be the case.

In operation, the controller 205, executing suitable program code, can identify a selected address and cause a message to be transmitted that requests a reverse directory lookup for the selected address. The request can be transmitted from network adapter 210 and/or 215. A response can be received by one of the network adapters 210 or 215 and provided to the controller 205. The controller 205 can cause the contact information received from the reverse directory lookup function, whether received over the wireless Internet connection or as a text message, to be displayed upon the display 230 or stored, for example, within an address book maintained in memory of the mobile device 200.

FIG. 3 is a view of a graphical user interface (GUI) 300 in accordance with another aspect of the present invention. The GUI 300 is one example of a list of received communications, in this case telephone calls, which can be presented upon the display of the mobile device. As shown, for those telephone numbers that are specified within an address book maintained by the mobile device, the names associated with the telephone numbers are displayed rather than the telephone number itself. In this example, a user of the mobile device has selected a number “(123) 456-7890” as the telephone number for which a reverse directory lookup function is to be performed.

In one embodiment, the user can provide an input that selects the telephone number. The user can provide a further input that causes menu 305 to be displayed. For example, the user can select the “menu” key 310. In another embodiment, the menu 305 can be displayed responsive to a single user input, e.g., actuation of a programmable key or other control on the mobile device. In still another embodiment, the menu 305 can be presented responsive to a user selection of the number “(123) 456-7890”. For example, the mobile device can indicate that no address book entry corresponds to the number since no name is displayed. Accordingly, for such numbers, the mobile device can be programmed to present a menu, such as menu 305, responsive to a user selection of the number.

In another embodiment, the mobile device can be configured to continually review the list of received communications and upon detecting an address that is not specified in the address book, automatically initiate a reverse directory lookup function for the address. In another embodiment, responsive to receiving a communication from an address that is not listed in the address book, the mobile device can initiate the reverse directory lookup function. In any case, as shown, the menu 305 includes a “3 Find” option, which is highlighted. Selection of the “3 Find” option can cause the mobile device to generate and send a reverse directory lookup request to the RDLS.

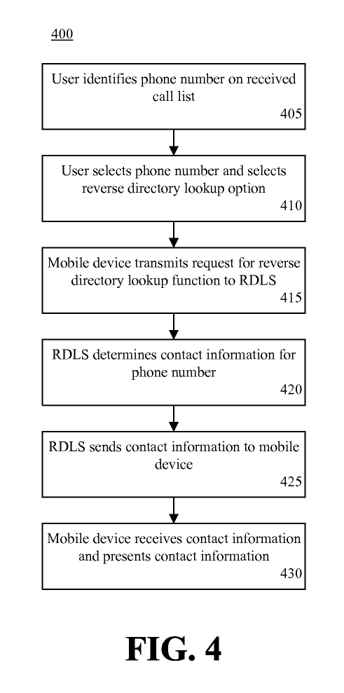

FIG. 4 is a flow chart illustrating a method 400 of retrieving contact information in accordance with another aspect of the present invention. The method can be implemented by a mobile device and system, such as those illustrated with reference to FIGS. 1-3. Though the method 400 is described in the context of a mobile phone and received calls, as noted, the present invention can be extended to any of a variety of different forms of communication.

Accordingly, in step 405, the user of the mobile device can identify a telephone number from a list of received calls. The telephone number can be an unidentified telephone number, e.g., one that is not specified within the address book of the mobile device. Alternatively, the telephone number identified by the user can be one that is specified within the address book of the mobile device. In step 410, the user can select the telephone number and further select a reverse directory lookup option for the telephone number. As noted, while the user can select the telephone number and select the reverse directory lookup function, selection of the telephone number can be automated as previously discussed. Further the reverse directory lookup function also can be automatically initiated if so desired.

Continuing with step 415, the mobile device can transmit a request for a reverse directory lookup function for the selected telephone number. As noted, the request can be sent via a wireless Internet connection or via a voice channel depending upon the particular RDLS that is used. In step 420, the RDLS can determine the contact information for the provided telephone number. In step 425, the RDLS can send the contact information for the selected telephone number to the mobile device. In step 430, the mobile device can receive the contact information and present the contact information upon the display.

It should be appreciated that the mobile device can perform other functions with respect to the received contact information. In one embodiment, where the telephone number is not specified in the address book of the mobile device, the mobile device can query the user whether the contact information should be stored. In this sense, the data can be stored manually, e.g., responsive to a user input requesting that the contact information be stored. In another embodiment, however, the mobile device can automatically create and store an entry in the address book. The entry can specify the selected telephone number as well as any contact information that is received.

In another embodiment, for example where the telephone number is already specified within an entry of the address book, the mobile device can update any information within the entry according to the contact information received from the RDLS. In cases where the information conflicts with other information, or will overwrite information already stored in the entry, the user can be presented with a prompt asking whether to overwrite one or more items of information for the entry in the address book using the newly received, or determined, contact information for the selected address.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an”, and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to the embodiments thereof, it will be apparent that modifications and variations are possible without departing from the scope of the invention defined in the appended claims.

What is claimed is:

1. Within a mobile device, a method of determining contact information comprising:
selecting an address from a list of communications received by the mobile device;
requesting, over a wireless connection, contact information for the selected address; and
receiving, over the wireless connection, contact information for the selected address.

2. The method of claim 1, further comprising displaying the contact information.

3. The method of claim 1, further comprising first presenting the list of communications received by the mobile device, wherein the list comprises the selected address.

4. The method of claim 3, further comprising presenting a menu specifying a reverse directory lookup option for the selected address.

5. The method of claim 1, further comprising:
determining that the selected address is not specified within an address book of the mobile device; and
adding the selected address and the contact information into the address book of the mobile device.

6. The method of claim 1, further comprising:
determining that an entry exists in an address book of the mobile device that specifies the selected address; and
updating the entry according to the contact information.

7. The method of claim 1, wherein selecting the address further comprises automatically selecting an address that is not specified within an address book of the mobile device and initiating the requesting of contact information responsive to the selection of the address.

8. The method of claim 1, wherein selecting the address further comprises identifying an address of an incoming communication that is not specified within the address book of the mobile device and initiating the requesting of contact information responsive to the selection of the address.

9. A mobile device comprising:
at least one network adapter that communicates over a wireless connection;
a data storage device comprising addresses and associated contact information; and
a controller that initiates a reverse directory lookup function through the network adapter over the wireless connection for a selected address of a communication received by the mobile device.

10. The mobile device of claim 9, further comprising a display, wherein the controller causes a list of received communications to be presented upon the display, wherein the selected address is selected from the list of communications received by the mobile device.

11. The mobile device of claim 10, wherein responsive to a user command, the controller presents a menu specifying a reverse directory lookup function for the selected address.

12. The mobile device of claim 10, wherein the controller receives contact information responsive to the reverse directory lookup function and performs at least one of presenting the contact information upon the display or storing the contact information in the address book of the mobile device.

13. A computer program product comprising:
a computer-usable medium having computer-usable program code that determines contact information within a mobile device, said computer program product including:
computer-usable program code that selects an address from a list of communications received by the mobile device;
computer-usable program code that requests, over a wireless connection, contact information for the selected address; and
computer-usable program code that receives, over the wireless connection, contact information for the selected address.

14. The computer program product of claim 13, further comprising computer-usable program code that displays the contact information.

15. The computer program product of claim 13, further comprising computer-usable program code that first presents the list of communications received by the mobile device, wherein the list comprises the selected address.

16. The computer program product of claim 15, further comprising computer-usable program code that presents a menu specifying a reverse directory lookup option for the selected address.

17. The computer program product of claim 13, further comprising:
computer-usable program code that determines that the selected address is not specified within an address book of the mobile device; and
computer-usable program code that adds the selected address and the contact information into the address book of the mobile device.

18. The computer program product of claim 13, further comprising:
computer-usable program code that determines that an entry exists in an address book of the mobile device that specifies the selected address; and
computer-usable program code that updates the entry according to the contact information.

19. The computer program product of claim 13, wherein the computer-usable program code that selects the address further comprises computer-usable program code that automatically selects an address that is not specified within an address book of the mobile device and initiates the requesting of contact information responsive to the selection of the address.

20. The computer program product of claim 13, wherein the computer-usable program code that selects the address further comprises computer-usable program code that identifies an address of an incoming communication that is not specified within the address book of the mobile device and initiates the requesting of contact information responsive to the selection of the address.
